(19) United States
(12) Patent Application Publication
(10) Pub. No.: US 2012/0303970 A1
(43) Pub. Date: Nov. 29, 2012

(54) DATA STORAGE APPARATUS, STORAGE CONTROL APPARATUS AND DATA RECOVERY METHOD

(75) Inventors: Hidetoshi KOIKE, Kodaira-shi (JP); Nobuaki YOSHITAKE, Kawasaki-shi (JP)

(73) Assignee: KABUSHIKI KAISHA TOSHIBA, Tokyo (JP)

(21) Appl. No.: 13/412,495

(22) Filed: Mar. 5, 2012

(30) Foreign Application Priority Data
May 24, 2011 (JP) 2011-116191

(51) Int. Cl. G06F 12/14

(52) U.S. Cl. 713/189

(57) ABSTRACT

According to one embodiment, a data storage apparatus includes a read module, a data transfer module, and a table generator. The read module reads encrypted data, in specific units, from a storage medium. The data transfer module transfers the data read by the read module, to a first buffer area. The table generator acquires key generation ID data identifying a new encryption key being used and an old encryption key used before, while the data transfer module is transferring the data, and generates table data including the key generation ID data associated with the units of data, respectively. The key generation ID data identifies the new encryption key being used and the old encryption key used before.

### CROSS-REFERENCE TO RELATED APPLICATIONS

This application is based upon and claims the benefit of priority from prior Japanese Patent Application No. 2011-116191, filed May 24, 2011, the entire contents of which are incorporated herein by reference.

### FIELD

Embodiments described herein relate generally to a data storage apparatus having a function of encrypting data, a storage control apparatus, and a data recovery method.

### BACKGROUND

In recent years, data storage apparatuses, such as hard disk drives (hereinafter referred to as “disk drives”), have been developed, each configured to encrypt data for the security thereof, and to store the encrypted data in a storage medium, for example, a disk, and to read the encrypted data from the storage medium, decrypt the data and to transfer the decrypted data to a host system in response to a read command coming from the host system.

The data storage apparatus includes not only a disk drive, but also a solid-state drive (SSD) having flash memories as storage media. Any disk drive that has the function of encrypting and decrypting data is occasionally called a “self-encrypting disk (SED) drive.”

In the disk drive having the function of encrypting and decrypting data, only the latest encryption key (also known as a “new encryption key”) being used at preset is stored in an internal memory. On the other hand, the disk stores not only the data encrypted with the new encryption key, but also the data encrypted with the encryption key used before (also known as an “old encryption key”) is stored. The disk may store data encrypted with a plurality of old encryption keys, along with data encrypted with the new encryption key.

In this type of a disk drive, the data representing the history of using encryption keys (i.e., key generation data) is therefore written on the disk when any encrypted data is written on the disk. To read the data, the key generation data is checked, determining whether the data has been encrypted with the new encryption key. If the data has been encrypted with the new encryption key, it will be decrypted with the new encryption key. If the data has been encrypted with any old encryption key, it cannot be decrypted. In this case, initialized data or insignificant random data are generated.

The data storage apparatus such as a disk drive can operate in a write mode, in which the data read from the storage medium is temporarily saved in a buffer memory and then written back to the storage medium. More specifically, so-called data refreshing is performed, writing the data again in a track. As a recording magnetic field is applied to a track to write data at the track, it leaks to the adjacent tracks in most cases, inevitably influencing the data recorded in the adjacent tracks. Writing the data again in the adjacent tracks by the data refreshing, it is possible to suppress the influence of the leakage of magnetic field.

As pointed out above, the data encrypted with the new encryption key is stored in the disk, together with the data encrypted with the old encryption keys. Therefore, the disk drive does not decrypt the data read from the disk, but temporarily saves it in the buffer memory. Then, the disk drive analyzes the key generation data contained in the data read from the buffer memory, then isolates the new data encrypted with the new encryption key from the old data encrypted with any old encryption keys, and finally writes these data again on the disk.

The disk drive must therefore spend time analyzing the key generation data, and spend more time isolating and writing the new data and the old data. The operating efficiency of the disk drive should therefore be increased.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram explaining a configuration of a disk drive according to an embodiment.

FIG. 2 is a block diagram explaining a read process performed by the encryption/decryption module in the embodiment.

FIG. 3 is a schematic diagram explaining read data in the embodiment.

FIGS. 4A, 4B, 4C, 4D, 4E, 4F, 4G and 4H are schematic diagrams explaining key generation data according to the embodiment.

FIG. 5 is a schematic diagram explaining a process of transferring the key generation data in the embodiment.

FIG. 6 is a schematic diagram explaining a process of transferring data in the embodiment.

FIG. 7 is a flowchart explaining a read process performed in the embodiment.

FIG. 8 is a block diagram explaining a write process performed by the encryption/decryption module in the embodiment.

FIG. 9 is a block diagram showing an exemplary key generation data generator according to the embodiment.

FIGS. 10A, 10B, 10C, 10D, 10E, 10F, 10G and 10H are schematic diagrams explaining key generation data according to the embodiment.

FIG. 11 is a schematic diagram explaining write data according to the embodiment.

FIG. 12 is a flowchart explaining a write process according to the embodiment.

### DETAILED DESCRIPTION

Various embodiments will be described hereinafter with reference to the accompanying drawings.

In general, according to one embodiment, a data storage apparatus includes a read module, a data transfer module, and a table generator. The read module reads encrypted data, in specific units, from a storage medium. The data transfer module transfers the data read by the read module, to a first buffer area. The table generator acquires key generation ID data identifying a new encryption key being used and an old encryption key used before, while the data transfer module is transferring the data, and generates table data including the key generation ID data associated with the units of data, respectively. The key generation ID data identifies the new encryption key being used and the old encryption key used before.

[Configuration of the Data Storage Apparatus]

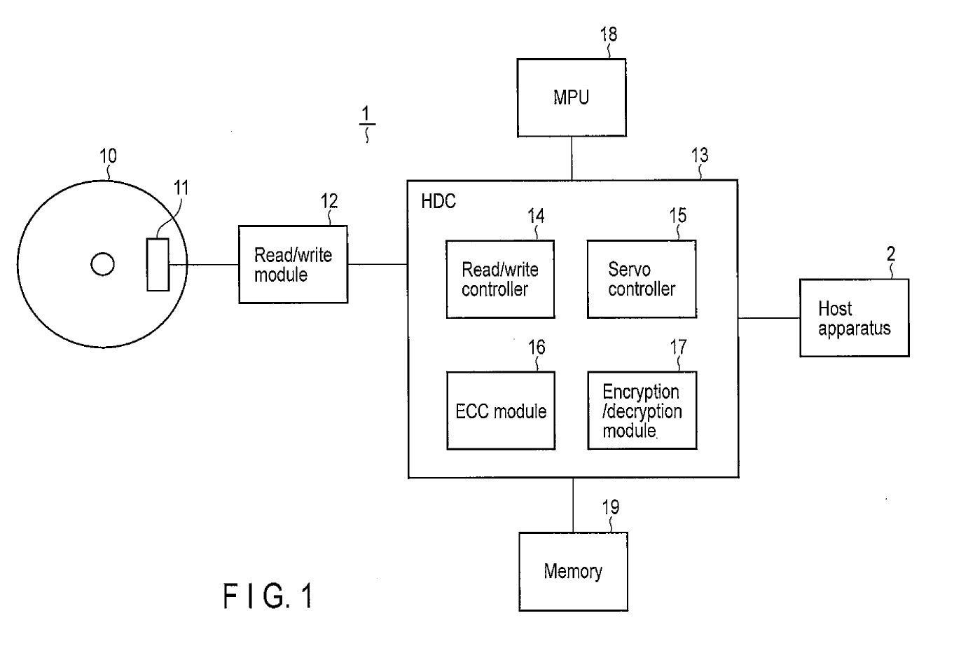

As seen from FIG. 1, the data storage apparatus according to this embodiment is a disk drive 1. The disk drive 1 is configured to receive data transferred from a host apparatus (e.g., computer or interface device) 2, to write the data on a disk 10, to read the data from the disk 10 and to transfer the data to the host apparatus 2. The data storage apparatus according to the embodiment is not limited to the disk drive 1, and can be a solid-state drive (SSD) that has flash memories as storage media.

The disk drive 1 has a head 11, a read/write module 12, a hard disk controller (HDC) 13, a microprocessor unit (MPU) 18, and a memory 19. The head 11 is mounted on an actuator (not shown) and can move over the disk 10 in the radial direction thereof, and is configured to write and read data at any designated track.

The read/write module 12, which is also called a “read/write channel,” processes read/write signals and supplies these signals to the head 11, reproduces data from any signal read from the disk 10, and converts data to be written on the disk 10, to a write signal.

The HDC 13 includes a read/write (R/W) controller 14, a servo controller 15, an error checking and correction (ECC) module 16, and an encryption/decryption module 17. In unison with the MPU 18, the HDC 13 performs interface control with respect to the host apparatus 2. Further, the HDC 13 uses the buffer area of the memory 19, and controls the data transfer to and from the host apparatus 2.

The R/W controller 14 uses the buffer area of the memory 19, and controls the data transfer to and from the read/write module 12. The servo controller 15 uses the servo data recorded on the disk 10, controlling the position of the head 11.

The ECC module 16 uses the error correction code (ECC) data added to the data read from the disk 10, thereby performing an error checking and correction (ECC) process. As will be described later in detail, the ECC module 16 further performs a process of encoding key generation data (also referred to as “latest/old key generation identification data”) identifying a new encryption key or an old encryption key. The ECC module 16 then adds the encoded key generation data to the ECC data, and performs a process of recovering the key generation data from the ECC data.

The encryption/decryption module 17 is constituted by hardware logic configured to use the new encryption key stored in an external memory, thereby to encrypting or decrypting data. The new encryption key is the latest encryption key being used at present. As will be described later, the encryption/decryption module 17 operates in so-called bypass mode, transferring data not encrypted or decrypted, to read and write data, ultimately in order to write the data back. Note that any one of the encryption keys used before is called an “old encryption key” with respect to the new encryption key.

[Process of Writing the Data Back]

The HDC 13 performs the process of writing the data back to the disk 10, thereby to achieve, for example, data refreshing. The operations of the HDC 13 will be explained. More precisely, the read process and write process will be described in the order they are mentioned.

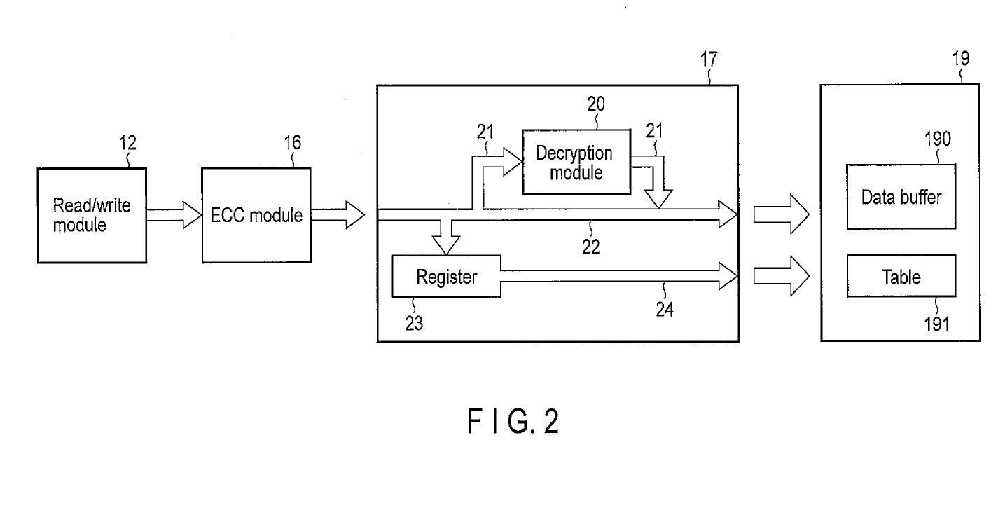

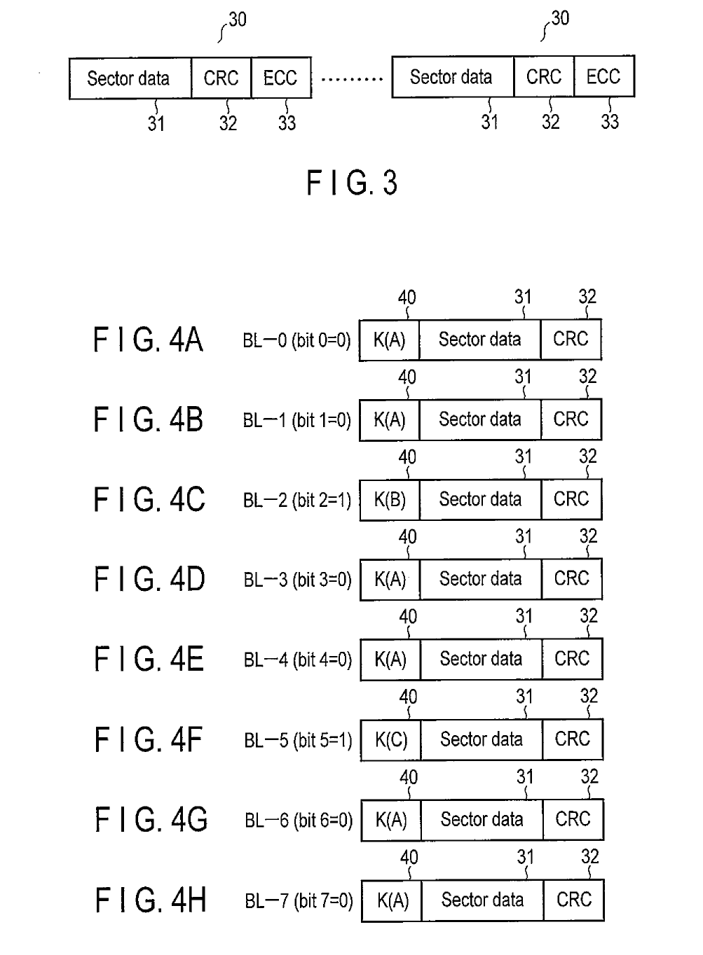

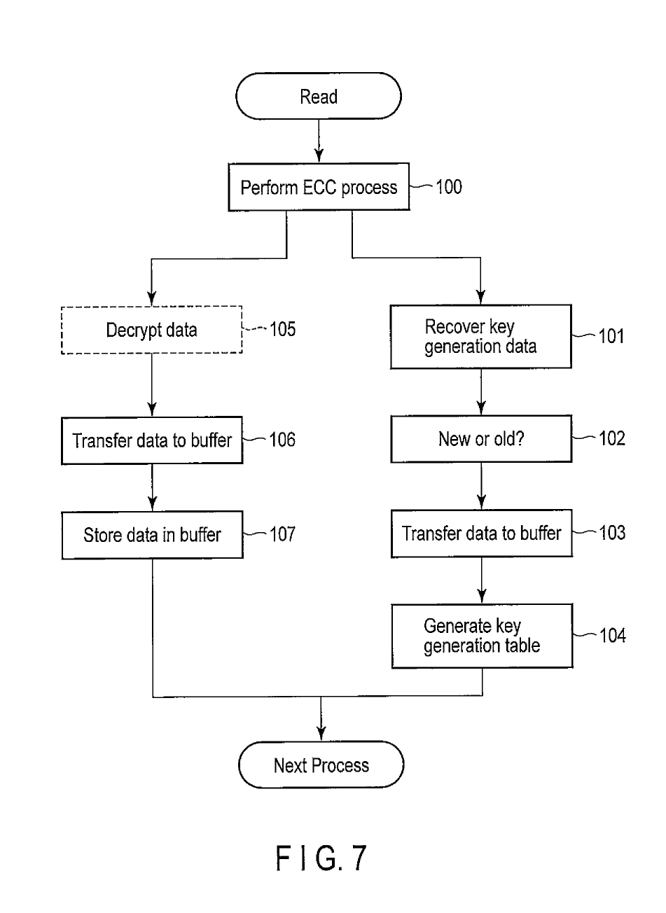

First, the read process will be described with reference to FIG. 2, FIG. 3, FIGS. 4A to 4H, FIG. 5, FIG. 6 and the flowchart of FIG. 7. The read process is a process of saving the data to be written back, temporarily in the memory 19.

FIG. 2 is a diagram schematically showing the configuration of the encryption/decryption module 17. The encryption/decryption module 17 is constituted by hardware logic as described above, and includes a decoder 20 as shown in FIG. 2.

As understood in FIG. 1, the HDC 13 performs a read process, reading data from the designated track of the disk 10, at which the data should be refreshed. In the read process, the servo controller 15 controls the actuator, moving the head 11 to the designated track (at which to refresh data). The head 11 reads the data, generating a read signal. The read/write module 12 reproduces data from the read signal and transmits the data to the HDC 13.

In the disk drive 1, data 30 in units of sectors are handled as access units. Many data 30 are recorded at one track, one continuous to another. Each data 30 consists of sector data 31, i.e., user data transferred from the host apparatus 2, a cyclic redundancy check (CRC) code 32, and ECC data 33.

In the HDC 13, the ECC module 16 uses the ECC data 33, performing an ECC process on each unit data 30, as shown in the flowchart of FIG. 7 (Block 100). The ECC module 16 then recovers the key generation data encrypted and contained in the ECC data (Block 101). The ECC module 16 outputs sector data 31 and CRC code 32, both acquired through the ECC process, together with the key generation data.

The encryption/decryption module 17 receives the key generation data from the ECC module 16 and holds the same in an internal register 23. In the encryption/decryption module 17, the sector data 31 and the CRC code 32, both output from the ECC module 16, are supplied through a bypass 22, not through a route 21 including the decoder 20 (Block 106). A CRC module (not shown) checks the sector data 31 and the CRC code 32 for errors.

In the encryption/decryption module 17, the sector data 31 the CRC code, both decoded by the decoder 20 may be directly transferred to the memory 19, not through the bypass 22 (Block 015). In this case, the sector data 31 is encrypted with the new encryption key. The sector data 31 encrypted with the old encryption key is converted to initialized data or to insignificant random data.

The HDC 13 stores the sector data 31 and CRC code 32 output from the encryption/decryption module 17, in a data buffer area 190 provided in the memory 19, as shown in FIG. 6 (Block 107). Thus, the data buffer area 190 holds the sector data 31 and the CRC code 32, both contained in the track at which data should be refreshed.

In the encryption/decryption module 17, the register 23 holds the key generation data (i.e., latest/old key generation identification data) recovered by the ECC module 16. From the key generation data, it is determined whether the encryption key being used is new or old (Block 102).

FIGS. 4A to 4H show, for convenience, only eight ECC-processed sectors (blocks) BL-0 to BL-7, respectively. Each sector indicates the relationship with the key generation data 40 recovered. The key generation data 40 may be K(A), K(B) or K(C). K(A) indicates that the sector data 31 has been encrypted with the new encryption key (i.e., key being used at present), K(B) indicates that the sector data 31 was encrypted with an old encryption key in a past generation, and K(C) indicates that the sector data 31 was encrypted with a different old encryption key in another past generation.

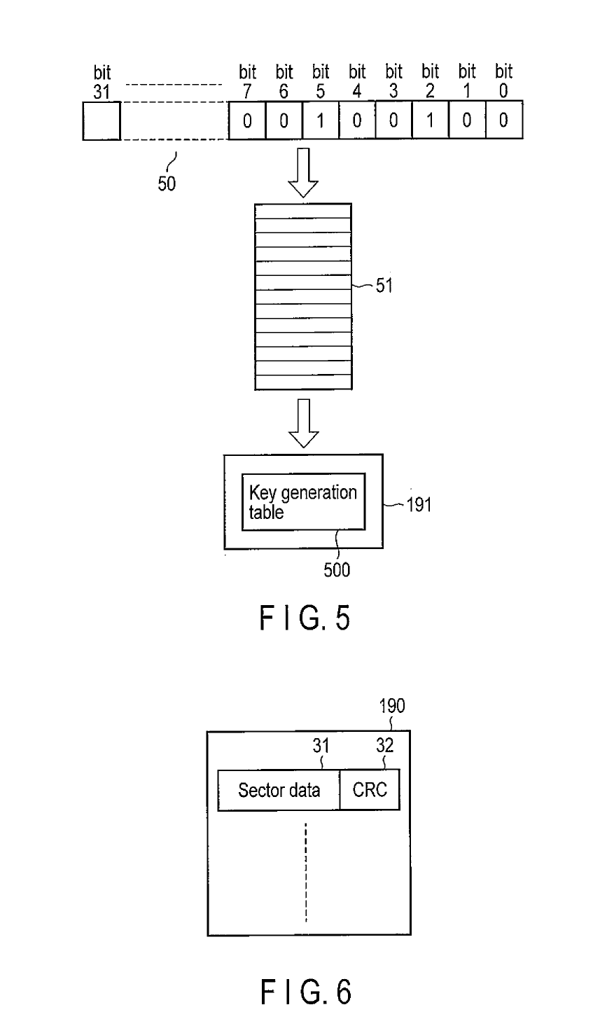

As shown in FIG. 5, the encryption/decryption module 17 has, for example, a 32-bit flip-flop 50, and temporarily holds a key generation data flag (either 0 or 1) indicating the encryption key used is new or old. If the key generation data 40 is K(A) indicating that sector data has been encrypted with the new encryption key, the key generation data flag is “0.” If the key generation data 40 is K(B) or K(C) indicating that sector data has been encrypted with an old encryption key, the key generation data flag is “1.”

As shown in FIG. 5, too, the encryption/decryption module 17 sets the key generation data flags, in units of 32 bits, in a first-in, first-out (FIFO) register 51 (Block 103). The HDC 13 stores the key generation data flags set in the FIFO register 51, in a data buffer area 191 of the memory 19 provided along with the above-mentioned data buffer area 190.

As shown in the flowchart of FIG. 7, the HDC 13 stores the key generation data flags, sequentially in the data buffer area 191, generating a key generation table 500 showing key generation data flags (Block 104). That is, the key generation table 500 is table data consisting of the key generation data flags associated with the respective sector data 32 stored in the data buffer area 190, as shown in FIGS. 4A to 4H.

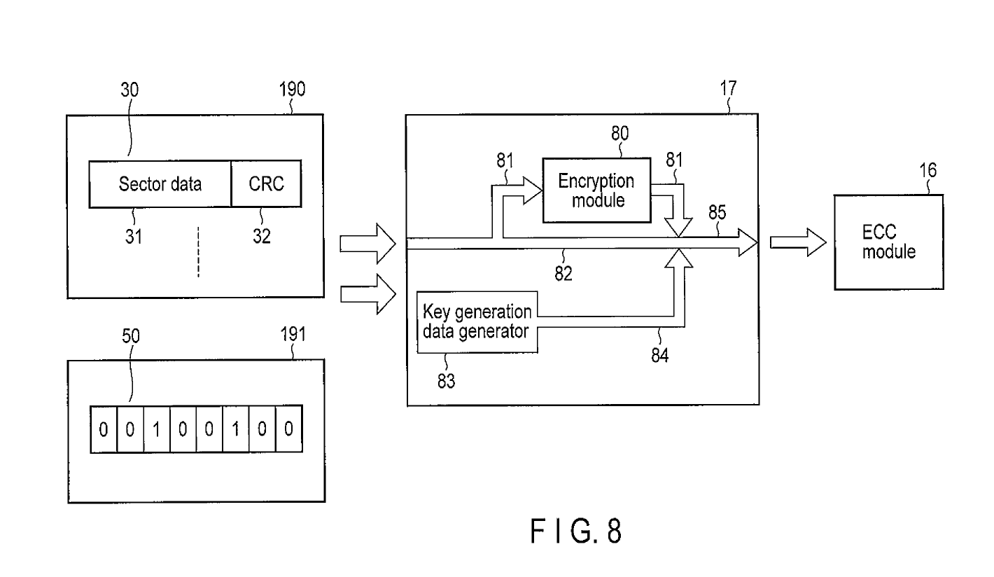

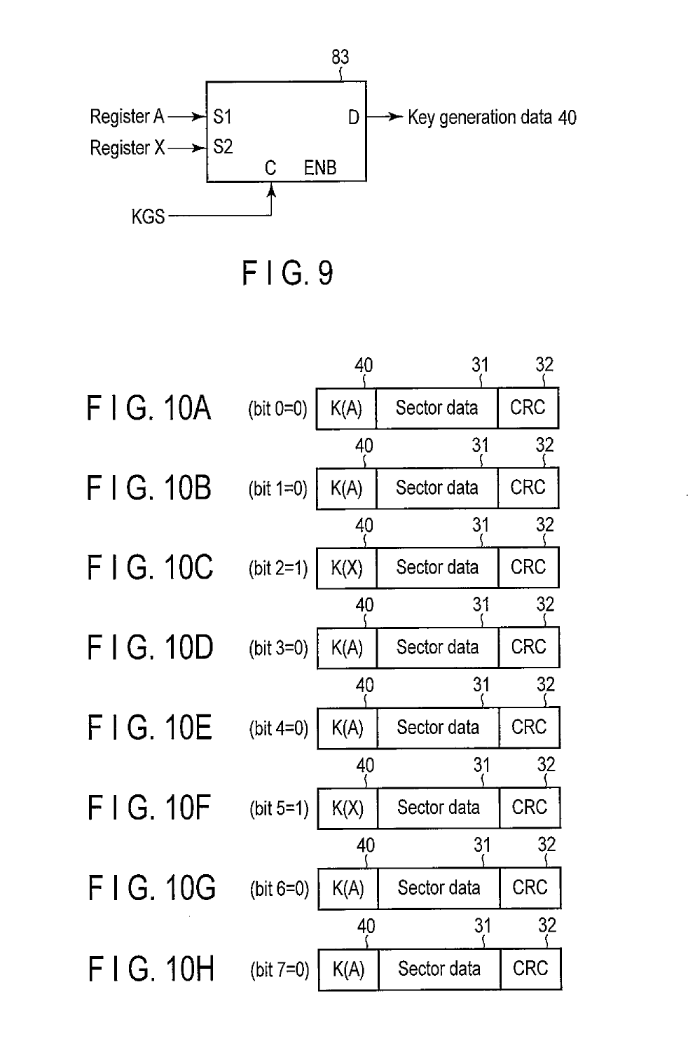

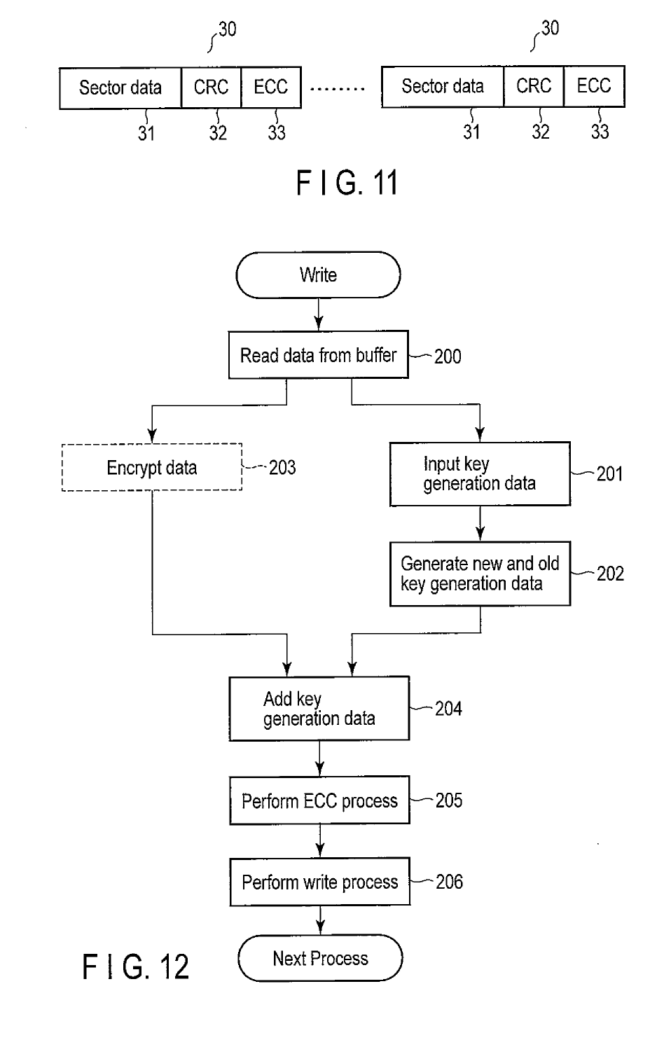

The process of writing the data back will be explained with reference to FIG. 8, FIG. 9, FIGS. 10A to 10H, FIG. 11 and the flowchart of FIG. 12. In this process, the data read from the track at which to refresh data is written back to this track of the disk 10.

FIG. 8 is a diagram schematically showing the configuration of the encryption/decryption module 17 used to write the data back to the disk 10. As described above, the encryption/decryption module 17 is constituted by hardware logic, and includes a decryption module 80.

As shown in the flowchart of FIG. 12, the HDC 13 reads the data 30 temporarily saved in units of sectors from the data buffer area 190 of the memory 19 and transfers the data 30 to the encryption/decryption module 17 (Block 200). The encryption/decryption module 17 transfers the data 30 (i.e., sector data 31 and CRC codes) read from the data buffer area 190, to the decryption module 80 through a bypass 82, not through a route 80 including a decoder 30. If the data 30 was decoded by the decoder 20 in the read process described above, the data 30 (i.e., sector data 31 and CRC code 32) is encrypted by the decryption module 80, not supplied through the bypass 82 (Block 203).

As shown in the flowchart of FIG. 12, the HDC 13 reads the key generation data flags 50 associated with the data 30 read to the data buffer area 190 from the key generation table 500 stored in the data buffer area 191 (Block 200). The encryption/decryption module 17 has a key generation data generator 83. The key generation data generator 83 receives the key generation data flags 50 (Block 201). The key generation data generator 83 is such a multiplexer shown in FIG. 9. In synchronism with the data 30 it receives, the key generation data generator 83 generates new key generation data and old key generation data (Block 202).

More precisely, as seen from FIG. 9, the key generation data generator 83 (multiplexer) selects either the new key generation data K(A) held in a register A and representing the latest encryption key or the old key generation data K(X) held in a register X and representing the old encryption key use in the past, in accordance with a selection signal KGS. The key generation data generator 83 then outputs the selected key generation data as key generation data 40. The selection signal KGS corresponds to the value (0 or 1 of the key generation data flag.

As shown in FIGS. 10A to 10H, in synchronism with the data 30 it receives, the key generation data generator 83 outputs the new key generation data K(A) as key generation data 40, if the data 30 is associated with the flag 0. If the data 30 is associated with the flag 1, the key generation data generator 83 outputs the old key generation data K(X) as key generation data 40. The old key generation data K(X) is the key generation data K(B) or the key generation data K(C), either used in the past.

With reference to the flowchart of FIG. 12 again, the encryption/decryption module 17 adds the key generation data 40 transferred via a bypass 84 (shown in FIG. 8) to the data 30 transferred via the bypass 82. The data 30 and the data 40 are sent to the ECC module 16 through a bypass 85 (shown in FIG. 8) (Block 204). As shown in FIG. 11, the ECC module 16 performs the ECC process on the sector data 31, calculating ECC data 33 (Block 205). In this case, the ECC module 16 encodes the key generation data 40 and adds the same to the ECC data 33.

With reference to the flowchart of FIG. 12 again, the HDC 13 receives the data 30 subjected to the ECC process in the ECC module 16 and transfers the data 30 to the read/write module 12. The read/write module 12 writes the data 30 back at the track, where the data is refreshed (Block 206). To be more specific, the servo controller 15 controls the actuator, moving the head 11 to the designated track (at which to refresh data) as shown in FIG. 1. The read/write module 12 supplies the head 11 with a write signal corresponding to the data 30 transferred from the HDC 13. The track, where data should be refreshed, may be identical to the track where data has been refreshed before or may be a track different from that track.

As has been described, to write data back to the disk in this embodiment in order to achieve data refreshing, the key generation data 40 can be collected, forming a key generation table 500 and storing the table 500 in the data buffer area 191, while the data read from the disk 10 in the read process is being saved in the data buffer area 190. Hence, the disk drive 1 can simultaneously save the data and generate the key generation data 40, while the disk 10 is rotating once.

Moreover, in the write process, the key generation data 40 can be generated while the data is being acquired from the data buffer area 190. The data can be written back to the disk 10, together with the key generation data 40, while the disk 10 is rotating once.

Hence, the data can be written back to the disk 10 to achieve data refreshing, at a higher speed than otherwise. This can increase the data refreshing efficiency in the data storage apparatus that has the function of encrypting and decrypting data. The technique of writing the data back to the disk 10 is advantageous, particularly in any data storage apparatus that does not record key generation data 40 directly on the storage medium.

The embodiment described above is based on the assumption that the encryption/decryption module 17 is constituted by hardware logic. Nonetheless, the encryption/decryption module 17 can be a software module instead, if the saving of the data and the collecting of the key generation data can be performed at the same time. The embodiment can is applied not only to a disk drive, but also to a data storage apparatus, such as an SSD, in which data must be subjected to wear-leveling control or a refreshing process.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data storage apparatus comprising:
a read module configured to read encrypted data, in units, from a storage medium;
a data transfer module configured to transfer the data read by the read module, to a first buffer area; and
a table generator configured to acquire key generation ID data identifying a new encryption key being used and an old encryption key used before, while the data transfer module is transferring the data, and to generate table data including the key generation ID data.

2. The data storage apparatus of claim 1, wherein the table generator is configured to set first data representing the new encryption key and second data representing any old encryption keys, as the key generation ID data.

3. The data storage apparatus of claim 1, further comprising a transfer module configured to transfer the table data generated by the table generator to a second buffer area different from the first buffer area.

4. The data storage apparatus of claim 1, further comprising a decoder configured to decode the data read by the read module, with the new encryption key.

5. The data storage apparatus of claim 1, further comprising:
a module configured to acquire, from the table data, the key generation ID data and write the units of data from the first buffer area, back to the storage medium; and
a write module configured to write the data, together with the key generation ID data, back to the storage medium.

6. The data storage apparatus of claim 5, wherein the write module is configured to write the data, together with the key generation ID data, back at same position as where the data was read from the storage medium.

7. The data storage apparatus of claim 5, wherein the write module is configured to write the data, together with the key generation ID data, back at a position different from a position where the data has been read from the storage medium.

8. The data storage apparatus of claim 5, further comprising an encryption module configured to encrypt the units of data read from the buffer area before the write module writes the data.

9. A storage control apparatus comprising:
a data transfer module configured to transfer input data to a first buffer area; and
a table generator configured to acquire key generation ID data identifying a new encryption key being used and an old encryption key used before, while the data transfer module is transferring the data, and to generate table data including the key generation ID data.

10. The storage control apparatus of claim 9, wherein the table generator is configured to set first data representing the new encryption key and second data representing any old encryption keys, as the key generation ID data.

11. The storage control apparatus of claim 9, further comprising a transfer module configured to transfer the table data generated by the table generator to a second buffer area different from the first buffer area.

12. The storage control apparatus of claim 9, further comprising a decoder configured to decode the data read by the read module, with the new encryption key.

13. The storage control apparatus of claim 9, further comprising:
a module configured to acquire, from the table data, the key generation ID data and write the units of data from the first buffer area, back to the storage medium; and
a write module configured to write the data, together with the key generation ID data, back to the storage medium.

14. A data recovery method for use in a data storage apparatus configured to write encrypted data in units to a storage medium and read the encrypted data from the storage medium, the method comprising:
transferring the data read from the storage medium, to a first buffer area; and
acquiring key generation ID data identifying a new encryption key being used and an old encryption key used before, while the data is being transferred to the first buffer area; and
generating table data including the key generation ID data.

15. The data recovery method of claim 14, wherein generating comprises setting first data representing the new encryption key and second data representing any old encryption keys, as the key generation ID data.

16. The data recovery method of claim 14, further comprising transferring the table data to a second buffer area different from the first buffer area.

17. The data recovery method of claim 14, further comprising decoding the data read by the data storage apparatus, with the new encryption key.

18. The data recovery method of claim 14, further comprising:
acquiring, from the table data, the key generation ID data and writing the units of data from the first buffer area, back to the storage medium; and
writing the data, together with the key generation ID data, back to the storage medium.
